(19) United States
(12) Patent Application Publication
(10) Pub. No.: US 2011/0040571 A1
(43) Pub. Date: Feb. 17, 2011

(54) SYSTEM AND METHOD FOR PROVIDING FOR TELEDERMATOLOGY

(76) Inventor: Felicity Warren, Atlanta, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/856,122

(22) Filed: Aug. 13, 2010

Related U.S. Application Data
(60) Provisional application No. 61/233,886, filed on Aug. 14, 2009.

(51) Int. Cl. G06Q 50/00; G06Q 10/00

(52) U.S. Cl. 705/2

(57) ABSTRACT

The exemplary embodiments of the present invention provide a system and method for providing teledermatology services on a computer system. The method comprises receiving a request from a client for skin analysis and associating the request to at least one skin condition. The method further comprises constructing an action plan for treating the at least one skin condition, and sending the action plan to the client. The system includes a tangible storage medium readable by the instruction processing system and storing instructions for execution by the instruction processing system, a means for receiving a request from a client for skin analysis and a means for associating the request to at least one skin condition. The system further includes a means for constructing an action plan for treating the at least one skin condition; and a means for sending the action plan to the client.

### CROSS-REFERENCE TO RELATED APPLICATIONS

This application claims the benefit of U.S. Provisional Patent Application 61/233,886, filed on Aug. 14, 2009, entitled “SYSTEM AND METHOD FOR PROVIDING FOR TELEDERMATOLOGY”, which is incorporated by reference herein in its entirety.

### BACKGROUND OF THE INVENTION

1. Field of the Invention

The present invention generally relates to Telemedicine; and more particularly to a system and method of delivering Teledermatology.

2. Description of Background

A significant shortage and mal-distribution of dermatologists exists in the US. This problem is particularly acute in rural or remote locations. It is in these rural or remote locations that complex or unusual dermatological maladies often arise because of exposure to manufactured agricultural or industrial chemicals or contact with natural chemicals produced by plants or animals. This shortage and mal-distribution of dermatologists in rural or remote locations has caused significant problems for those clients having dermatological disorders and needing a referral to a physician trained in dermatology for proper diagnosis, recommendation of a treatment regimen, and a plan for follow-up.

Compounding the problem of the shortage and mal-distribution of dermatologists is the continued increase in usage for a cosmetic counter, infomercial or general practitioner to start treatment for a skin condition (i.e. acne). This course of unsupervised treatment leads to client frustration, dissatisfaction, further damaged skin including scarring, poor self-esteem, loss of work time for appointments as well as loss of income. The cost of unsupervised treatment further includes millions of dollars that are spent by clients on cosmeceuticals (i.e. a combination of cosmetics and pharmaceuticals) which are sold by a sales clerk with experience only in sales and none in the skin, physiology, mechanisms of action of products, or dermatologics.

However, a need still remains in the art for a simplified system and method to both track, facilitate secure and rapid consultation between a client suffering from a dermatological disorder and a physician with expertise in diagnosing, recommending a treatment regimen, and creating a follow-up plan for dermatological disorders.

### SUMMARY OF THE INVENTION

Embodiments of the present invention provide a system, method and computer program products for providing teledermatology services on a computer system.

An exemplary embodiment includes a method for providing teledermatology services on a computer system. The method comprises receiving a request from a client for skin analysis and associating the request to at least one skin condition. The method further comprises constructing an action plan for treating the at least one skin condition, and sending the action plan to the client.

Another exemplary embodiment includes a system for providing teledermatology services on a computer system. Briefly described in terms of architecture, one embodiment of the system, among others, is implemented as follows. The system includes a tangible storage medium readable by the instruction processing system and storing instructions for execution by the instruction processing system, a means for receiving a request from a client for skin analysis and a means for associating the request to at least one skin condition. The system further includes a means for constructing an action plan for treating the at least one skin condition; and a means for sending the action plan to the client.

A further exemplary embodiment includes a computer program product for providing teledermatology services on a computer system. The computer program product includes a tangible storage medium readable by a computer system and storing instructions or execution by the computer system for performing a method. The method comprises receiving a request from a client for skin analysis and associating the request to at least one skin condition. The method further comprises constructing an action plan for treating the at least one skin condition, and sending the action plan to the client.

These and other aspects, features and advantages of the invention will be understood with reference to the drawing figure and detailed description herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of the network environment for the teledermatology services of the present invention.

FIG. 2A is a block diagram illustrating an example of a server utilizing the teledermatology services of the present invention, as shown in FIG. 1.

FIG. 2B is a block diagram illustrating an example of a remote device utilizing the remote device system, as shown in FIG. 1.

FIG. 3 is a flow chart illustrating an example of the operation of the teledermatology services system for the host of the present invention utilized by the server, as shown in FIGS. 2A.

FIG. 4 is a flow chart illustrating an example of the operation of the client configure process on the server that is utilized in the teledermatology services system of the present invention, as shown in FIGS. 2A-3.

FIG. 5 is a flow chart illustrating an example of the operation of the client analysis process on the server that is utilized in the teledermatology services system of the present invention, as shown in FIGS. 2A-3.

FIG. 6 is a flow chart illustrating an example of the operation of the product ordering process on the server that is utilized in the teledermatology services system of the present invention, as shown in FIGS. 2A-3.

FIG. 7 is a flow chart illustrating an example of the operation of the remote device system on the host that is utilized in the teledermatology services system of the present invention, as shown in FIGS. 2B.

The detailed description explains the preferred embodiments of the invention, together with advantages and features, by way of example with reference to the drawings.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

The invention described hereafter is applicable on all remote devices connected to a server hosting the teledermatology system and method of the present invention. While described below with respect to a single computer, the system and method for a webpage build system is typically implemented in a networked computing environment in which a number of computing devices communicate over a local area network (LAN), over a wide area network (WAN), or over a combination of both LAN and WAN.

Telemedicine is evolving in all aspects of medicine, but one of its greatest utilities could be in the visual field of dermatology, particularly its use in the treatment of a skin condition (i.e. acne, rash or the like). Teledermatology in this context refers to the use of photographic images of a client electronically transmitted to the location of the treating dermatologist which would then be reviewed along with client health history, and other pertinent information as it pertains to treatment of the skin condition. Teledermatology may also be referred to as electronic dermatology or e-dermatology. Subsequently, within a 24-48 hour period the client treatment plan and medications is provided via mail, package delivery service (i.e. FedEx, UPS and the like) or picked-up at the location where client was evaluated. This document attempts to identify several methods of tailoring a teledermatology service to specific circumstances, such as but not limited to, a direct to consumer marketing plan in the treatment of acne. Additional methods include the addition of skin rejuvenation treatment plans.

Typically, the client uses a cosmetic counter, infomercial or general practitioner to start treatment for a skin condition (i.e. acne, rash or the like). This course of unsupervised treatment leads to patient, restoration, just satisfaction, further damaged skin including scarring, poor self-esteem, loss of work time for appointments as well as loss of income.

The system and method for teledermatology service of the present invention would be a great supplement to the general practitioner who may not provide a referral to a dermatologist, who is considered a specialist, this rational is promoted by insurance carriers to minimize specialty use. The use of a specialist typically requires a referral from the primary doctor and the cost for the patient will be higher.

It has been alleged that the general practitioner often rejects the idea of a referral and simply makes a recommendation for the patient to start the use of the heavily marketed product line, Proactiv, currently available over the counter. This line is sold from an infomercial, via a vending machine or small mall cart, with only the latter having any human contact, and certainly no input is provided by a clinician of any sort any time during treatment attempt. With the system and method for teledermatology service of the present invention, the general practitioner can confidently make a referral knowing that the patient treatment plan would incorporate a physical examination by store-and-foreword telemedicine to a board certified dermatologist, who would then create a treatment plan specifically for that client.

Pressure for services is more effective when arising from the consumer rather than from the provider which may require a variety of marketing tools similar to those used by big Pharma to provoke patients to ask physicians about advertised medications. Direct to consumer marketing in the form of infomercials used by other acne treatment “systems” could also be used to increase the success of the system and method for teledermatology service of the present invention. Early involvement of primary care physicians is important as a source of referrals. Direct marketing information would be provided to pediatricians, gynecologists; and other primary care physicians to improve referrals. High traffic mall cart/kiosk and possibly in mall marketing would be incorporated. The use of electronic advertisement via online services could also be incorporated.

According to the system and method for teledermatology services of the present invention, a treatment plan for a skin condition (i.e. acne, rash or the like) is generated for each client individually by the dermatologist. The treatment plan may initiate with the use nonprescription medication. The medication will only be available initially via the provider. The addition of the sale of prescription medications are considered and, added as needed or applicable. Another means of treatment to consider is that provided by personal computers and Internet services. Many clients may have computers which contain image-capturing devices. This will allow the clients to move to the web site for the system and method for teledermatology services of the present invention, capture their own photograph as directed by the web site to be forwarded to the service along with the client's completed questionnaires. Once payment (i.e. credit card) information has been provided a personalized treatment guide would be created by a board certified dermatologist after which the personalized products would be delivered to the client via mail, package delivery service or be picked up at the mall kiosk location.

In one embodiment, minimal overhead and high visibility are obtained through the use of a mall cart/kiosk to initiate the client consultation. The use of a medical assistant proficient at sales, or other licensed practitioner such as a physician's assistant or registered nurse would consult with the client. The client would complete a skin and medical, questionnaire via computer, as well as HIPAA and consent forms. The consultant will assist with the computer input if needed. Standardized photos would be obtained for store-and-forward technique, which as the name implies, the gathered information will, be downloaded and transferred to the dermatologist. The doctor would review the information and the digital photographs to create an individualized treatment plan based on the dermatologist's product line. The products and written treatment plan with product instructions and what to expect with the treatment would reach the client within 24-48 hours via return to the point of service or via mail service. At the time of initial, evaluation the client would enter into an agreement to continue to automatically receive medication on a monthly basis for 6 months for which the client would be charged via credit card. The initial consultation would incorporate a non-refundable doctor evaluation fee plus an amount for the clients' first month of medication. The client could return in 3 months for a follow-up photograph, which the consultant would use to show the client the progress with treatment in comparison to the pre-treatment photograph.

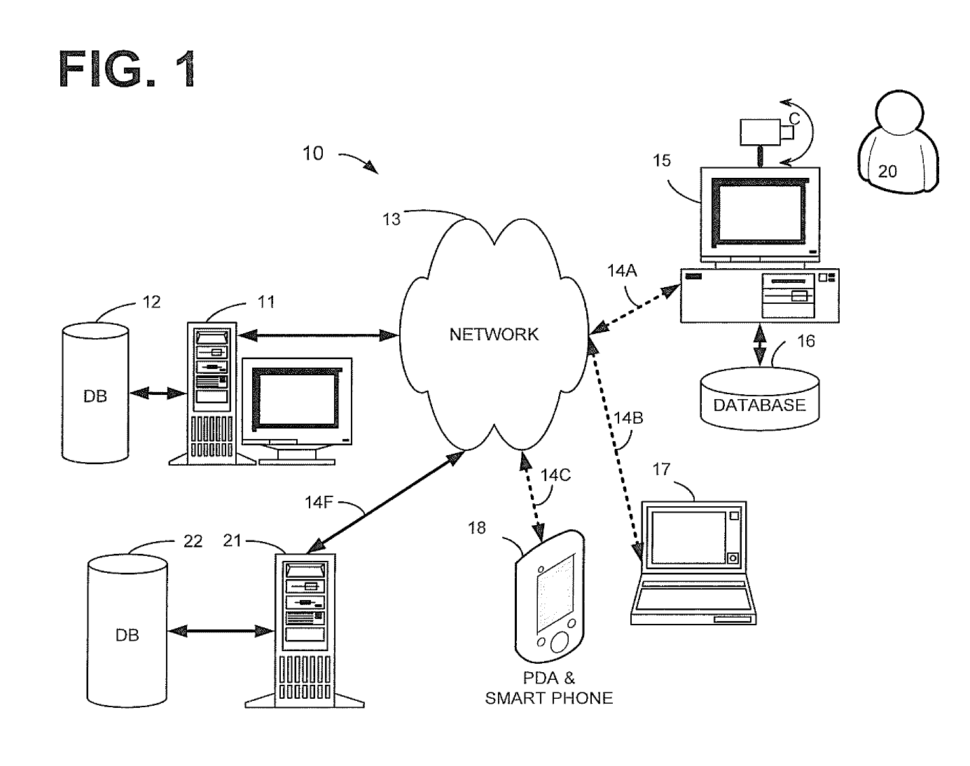

Referring now to the drawings, in which like numerals illustrate like elements throughout the several views. FIG. 1 illustrates an example of the basic components of a system 10 using the teledermatology services system used in connection with the preferred embodiment of the present invention. The system 10 includes a server 11 and the remote devices 15, 17, 18 or 21 that utilize the teledermatology services system of the present invention.

Each remote device 15, 17 and 18 has applications and can have a local database 16. Server 11 contains applications, and a database 12 that can be accessed by remote device 15, 17 and 18 via connections 14(A-C), respectively, over network 13. The server 11 runs administrative software for a computer network and controls access to itself and database 12. The remote device 15, 17 and 18 may access the database 12 over a network 13, such as but not limited to: the Internet, a local area network (LAN), a wide area network (WAN), via a telephone line using a modem (POTS), Bluetooth, WiFi, cellular, optical, satellite, RF, Ethernet, magnetic induction, coax, RS-485, the like or other like networks. The server 11 may also be connected to the local area network (LAN) within an organization (i.e. a hospital or medical complex).

The remote device 15, 17 and 18 may each be located at remote sites. Remote device 15, 17 and 18 include but are not limited to, PCs, workstations, laptops, handheld computer, pocket PCs, PDAs, pagers, WAP devices, non-WAP devices, cell phones, palm devices, printing devices and the like. Included with each remote device 15, 17 and 18 is an ability to obtain images of the client. In the remote device 15, there is a special camera for capturing images of client 20. In remote devices 17 and 18, they are maybe integrated cameras for acquiring images of the client or the ability to download photographs of client 20 in a digital form.

Thus, when a user at one of the remote devices 15, 17 and 18 desires to access teledermatology services status from the database 12 at the server 11, the remote device 15, 17 and 18 communicates over the network 13, to access the server 11 and database 12.

Third party vendors computer systems 21 and databases 22 can be accessed by the teledermatology services system 100 on server 11 in order to access product offerings and ordered products. Data that is obtained from third party vendors computer system 21 and database 22 can be stored on server 11 and database 12 in order to provide later access to the user on remote devices 15, 17 and 18. It is also contemplated that for certain types of data that the remote devices 15, 17 and 18 can access the third party vendors computer systems 21 and database 22 directly using the network 13.

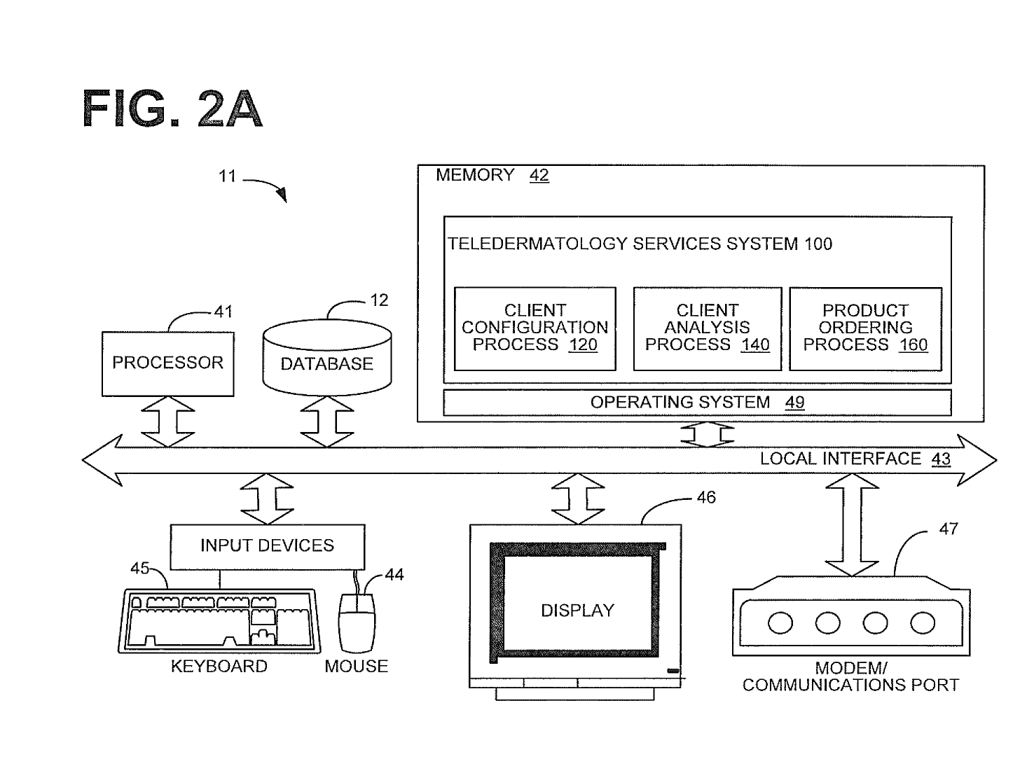

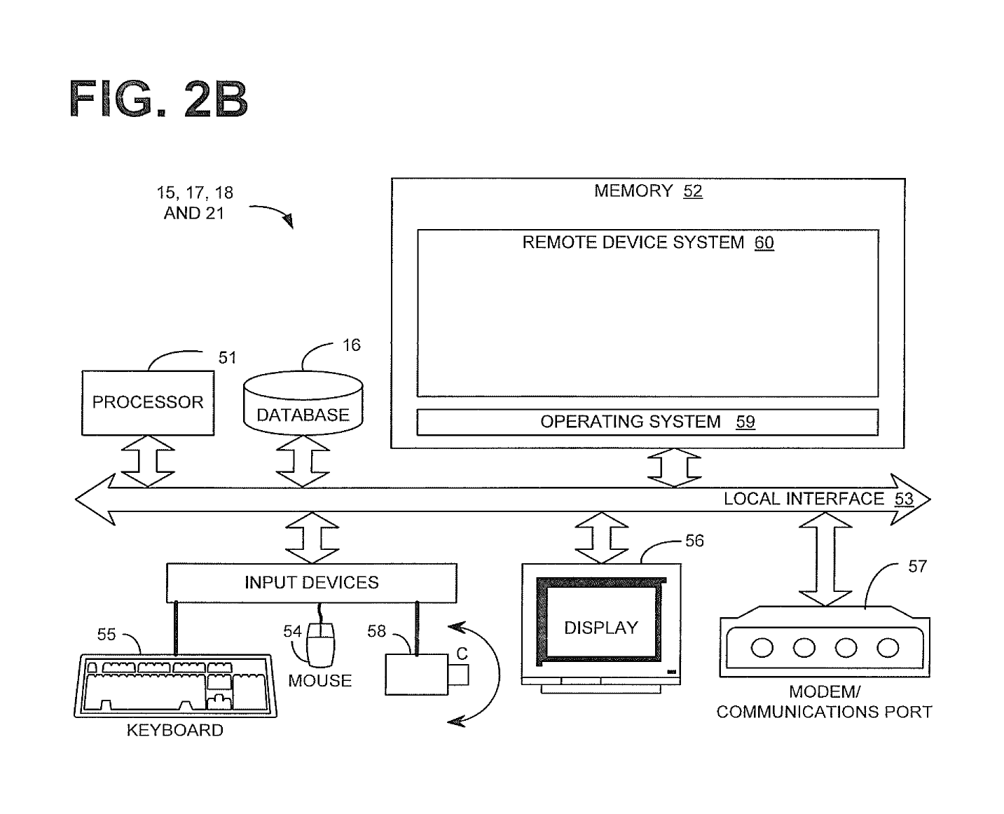

Illustrated in FIG. 2A is a block diagram demonstrating an example of server 11, as shown in FIG. 1, utilizing the teledermatology services system 100 of the present invention. Server 11 includes, but is not limited to, PCs, workstations, laptops, PDAs, palm devices and the like. Illustrated in FIG. 2B is an example demonstrating a remote devices 15, 17 and 18 utilizing the remote device system 200 of the present invention. The processing components of the third party vendors computer systems 21 are similar to that of the description for the server 11 (FIG. 2A).

Generally, in terms of hardware architecture, as shown in FIG. 2A, the server 11 include a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the server 11, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2A, the software in the memory 42 includes a suitable operating system (O/S) 49 and the teledermatology services system 100 of the present invention. As illustrated, the teledermatology services system 100 of the present invention comprises numerous functional components including, but not limited to, the client configure process 120, client analysis process 140 and product ordering process 160.

A non-exhaustive list of examples of suitable commercially available operating systems 49 is as follows (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 49 essentially controls the execution of other computer programs, such as the teledermatology services system 100, and provides scheduling, input-output control, file and data management, memory management, and communication control and related services. However, it is contemplated by the inventors that the teledermatology services system 100 of the present invention is applicable on all other commercially available operating systems.

The teledermatology services system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 49. Furthermore, the teledermatology services system 100 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote devices, other files, devices, systems, or a network), a radio frequency (RF) or other transceiver (not shown), a telephonic interface (not shown), a bridge (not shown), a router (not shown), etc.

If the server 11 is a PC, workstation, intelligent device or the like, the software in the memory 42 may further include a basic input output system (BIOS) (omitted for simplicity). The BIOS is a set of essential software routines that initialize and test hardware at startup, start the O/S 49, and support the transfer of data among the hardware devices. The BIOS is stored in some type of read-only-memory, such as ROM, PROM, EPROM, EEPROM or the like, so that the BIOS can be executed when the server 11 is activated.

When the server 11 is in operation, the processor 41 is configured to execute software stored within the memory 42, to communicate data to and from the memory 42, and generally to control operations of the server 11 are pursuant to the software. The teledermatology services system 100 and the O/S 49 are read, in whole or in part, by the processor 41, perhaps buffered within the processor 41, and then executed.

When the teledermatology services system 100 is implemented in software, as is shown in FIG. 2A, it should be noted that the teledermatology services system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, propagation medium, or other physical device or means that can contain or store a computer program for use by or in connection with a computer related system or method.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD RAN) (optical). Note that the computer-readable medium could even be paper or another suitable medium, upon which the program is printed or punched (as in paper tape, punched cards, etc.), as the program can be electronically captured, via for instance optical scanning of the paper or other medium, then compiled, interpreted or otherwise processed in a suitable manner if necessary, and then stored in a computer memory.

In an alternative embodiment, where the teledermatology services system 100 is implemented in hardware, the teledermatology services system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Illustrated in FIG. 2B is a block diagram demonstrating an example of functional elements in the remote device 15, 17 and 18, that enables access to the teledermatology services system 100 of the present invention, as shown in FIG. 2A. The remote devices 15, 17 and 18 provides access to the teledermatology services system 100 of the present invention on server 11 and database 12 using the remote devices system 60, including for example, but not limited to an Internet browser. The information accessed in server 11 and database 12 can be provided in the number of different forms including but not limited to ASCII data, WEB page data (i.e. HTML), XML or other type of formatted data.

Included with each remote device 15, 17 and 18 is an ability to obtain images of the client. In the remote device 15, there is a camera 58 for capturing images of client 20. In remote devices 17 and 18, they are maybe integrated cameras 58 for acquiring images of the client or the ability to download photographs of client 20 in a digital form.

As illustrated, the remote device 15, 17 and 18 and 21 are similar to the description of the components for server 11 described with regard to FIG. 2A. Hereinafter, the remote devices 15, 17 and 18 that will be referred to as remote devices 15 for the sake of brevity.

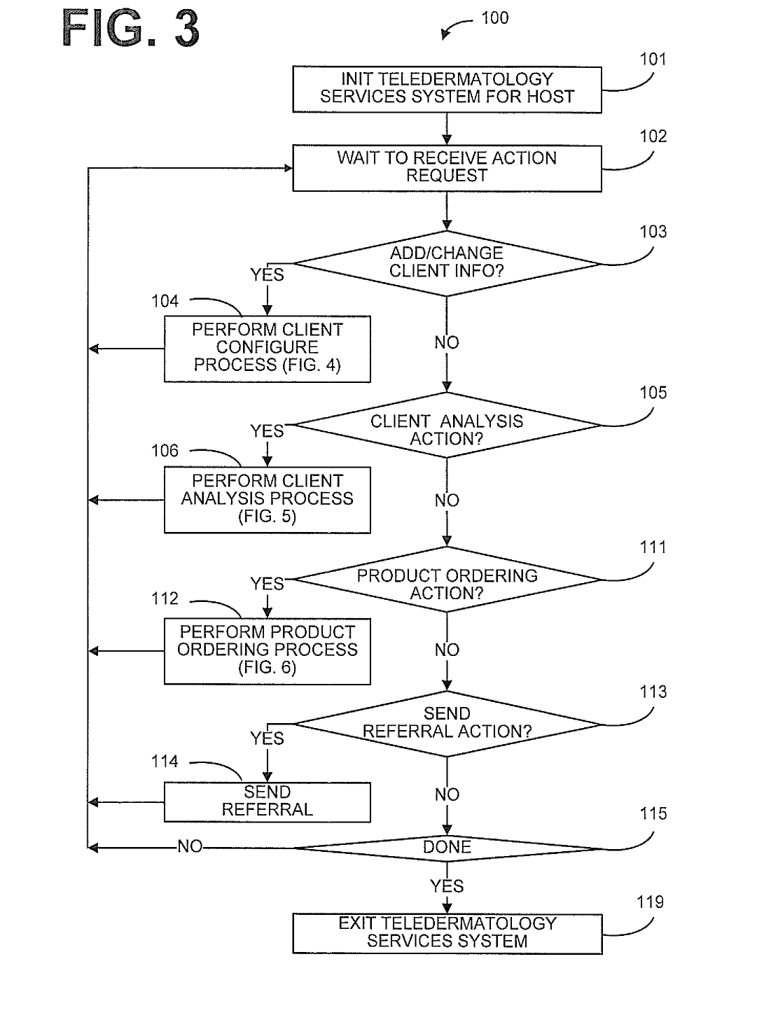

FIG. 3 is a flow chart illustrating an example of the operation of the teledermatology services system 100 of the present invention utilized by the server 11, as shown in FIG. 2A. The teledermatology services system 100 of the present invention provides a client with the ability to acquire a treatment plan by a dermatologist for a skin condition.

First at step 101, the teledermatology services system 100 is initialized. This initialization includes the startup routines and processes embedded in the BIOS of the server 11. The initialization also includes the establishment of data values for particular data structures utilized in the teledermatology services system 100.

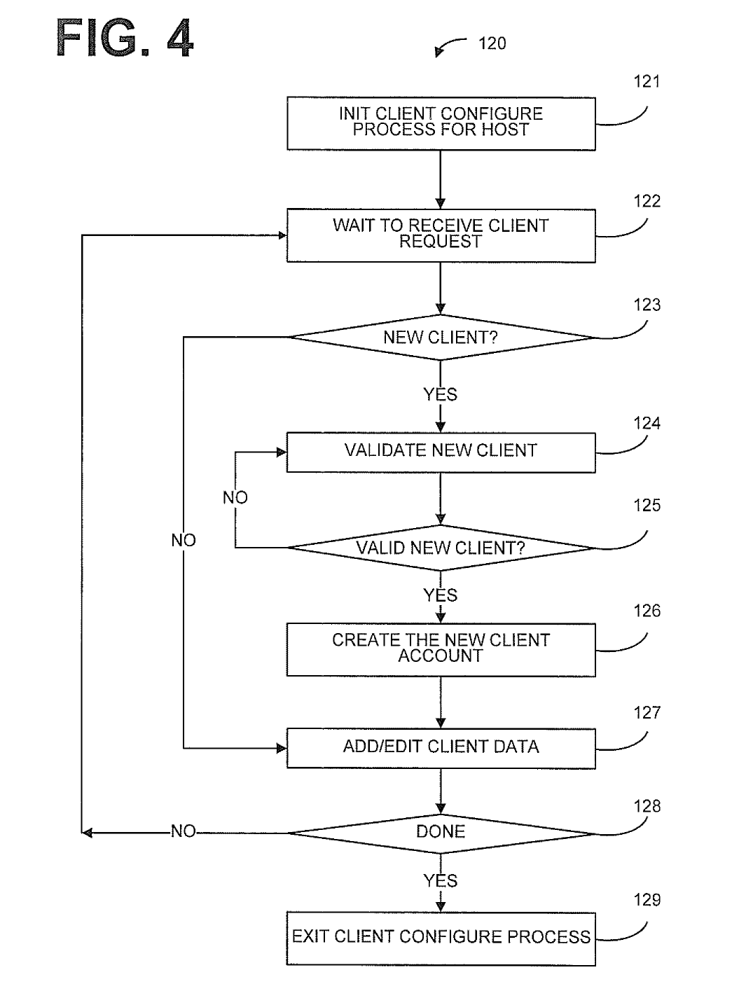

At step 102, the teledermatology services system 100 waits to receive an action request. Once an action is received at step 102, it is determined if the action is to add a new client to the service at step 103. If it is determined that the action is not to add a new client to the service, then the teledermatology services system 100 skip step 105. However, if it is determined in step 103 that a new client is to be added, then the teledermatology services system 100 performs the client configure process at step 104. The client configure process is herein defined in further detail with regard to FIG. 4. After performing the client configure process, the teledermatology services system 100 returns to step 102.

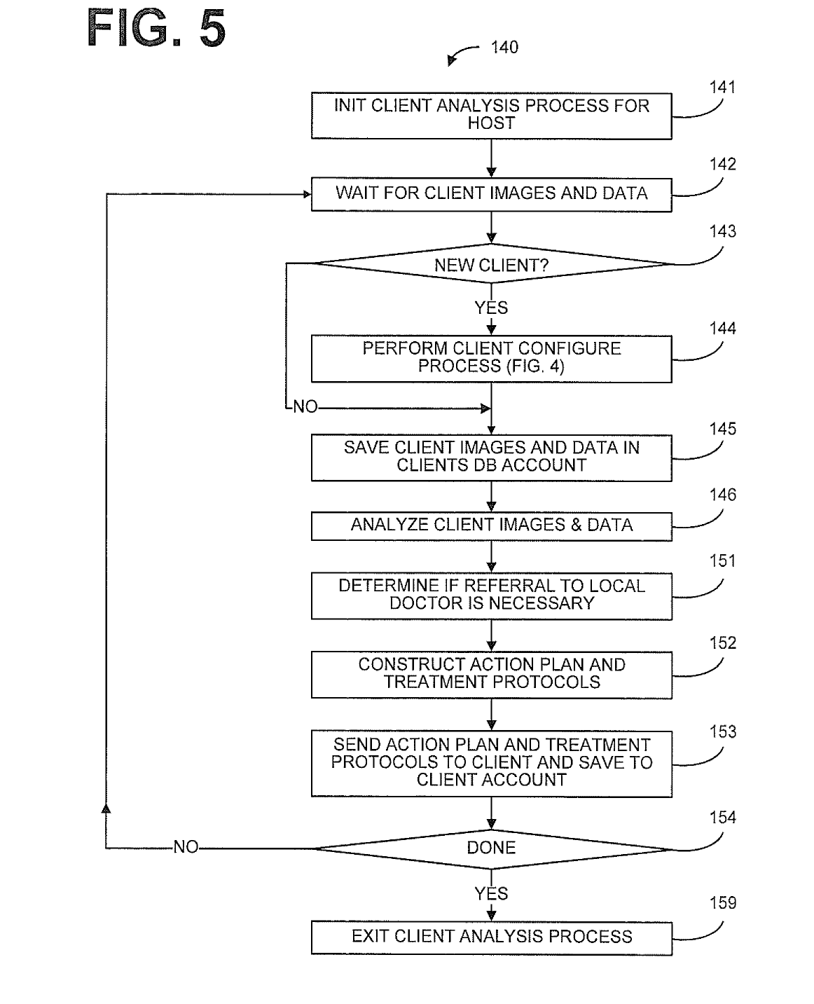

At step 105, it is determined if the action is a client analysis action. If it is determined that the action is not a client analysis action, then the teledermatology services system 100 skip step 111. However, if it is determined in step 105 that it is a client analysis action, then the teledermatology services system 100 performs the client analysis process at step 106. The client analysis process is herein defined in further detail with regard to FIG. 5. After performing the client analysis process, the teledermatology services system 100 returns to step 102.

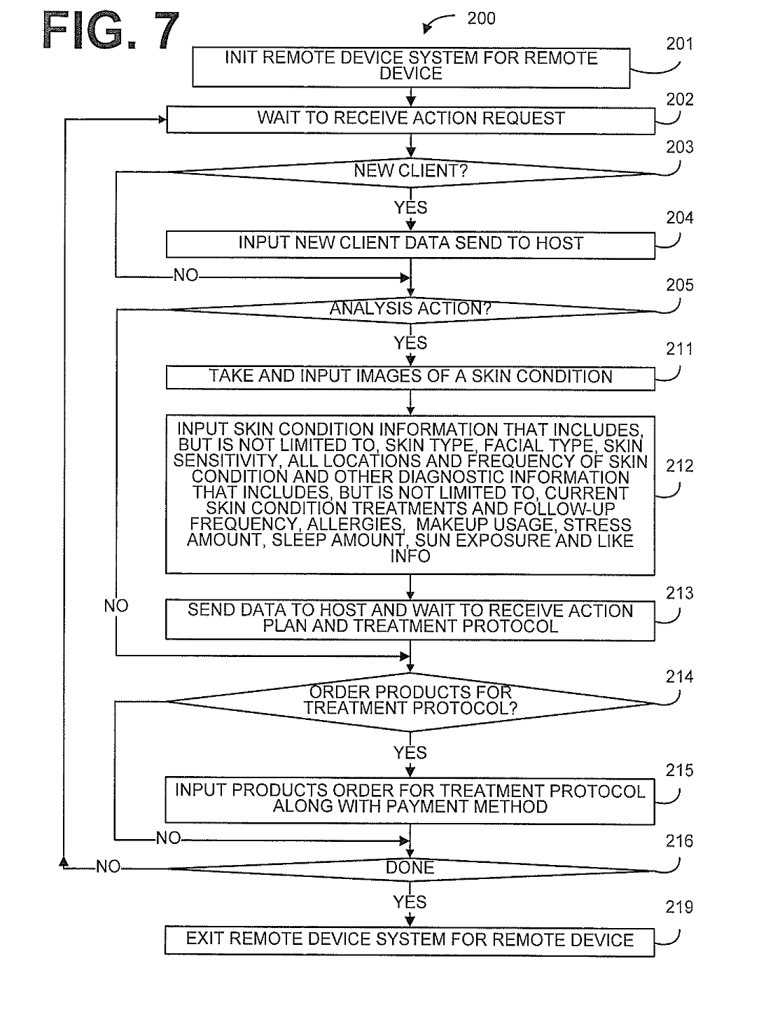

At step 111, it is determined if the action is a product ordering action, i.e. a sales revenue generation action. If it is determined that the action is not a product ordering action, then the teledermatology services system 100 skip step 113. However, if it is determined at step 111 that it is a product ordering action, then the teledermatology services system 100 performs the product ordering process at step 112. The product ordering process is herein defined in further detail with regard to FIG. 7. After performing the product ordering process, the teledermatology services system 100 returns to step 102.

At step 113, it is determined if the action is a referral action. A referral action is a situation where the dermatologist or image analysis software has determined that it is in the best interest of the client to see doctor in person. If it is determined that the action is not a referral action, then the teledermatology services system 100 skip this step 115. However, if it is determined at step 113 that a referral action is to be performed, then the teledermatology services system 100 performs the referral action at step 114. In a referral action, the client location is cross matched with a listing of doctors for a particular specialty after determining the closeness predetermined number of referrals, this information is sent to the client with the recommendation that the client make appointment as soon as possible with any one of the cross matched doctors. After performing the referral action, the teledermatology services system 100 returns to step 102.

At step 115, it is determined if the teledermatology services system 100 is to wait for additional action request. If it is determined at step 115 that the teledermatology services system is to wait to receive additional actions, then the teledermatology services system 100 returns to repeat steps 102 through 115. However, if it is determined at step 115 that there are no more actions to be received, then the teledermatology services system 100 then exits at step 119.

FIG. 4 is a flow chart illustrating an example of the operation of the client configure process 120 on the server that is utilized in the teledermatology services system 100 of the present invention, as shown in FIGS. 2A-3. The client configure process 120 establish or modify client specific information residing on database 12 (FIG. 2A).Once the new client information is placed in server 11, it is available for client analysis and product ordering. A brief overview of one exemplary process is as follows: 1) waits to receive a client configure request; 2) determine if the client is a new client; 3) Validate and store new client name; 4) upload new/modify existing client information from local machine; and 5) done.

First at step 121, the client configure process 120 is initialized. This initialization includes the startup routines and processes embedded in the BIOS of the server 11. The initialization also includes the establishment of data values for particular data structures utilized in the client configure process 120.

At step 122, the client configure process 120 waits to receive a new client request. Once a new client request has been received, the client configure process 120 determines if the client is a new client to the teledermatology services system 100. If it is determined at step 123 that the client is not a new client, then the client configure process 120 skip step 127 to enable the client to enter new or edit existing client data. However, if it is determined at step 123 that the client is a new client, then the client configure process 120 validates the new client at step 124. The new client is registered at this time and is validated against information in database 12 at step 125. If the new client is not valid, then the client configure process 120 returns to step 124. However, if the new client is valid, then the client configure process 120 enables the new client to create a new client account at step 126.

At step 127, the client configure process 120 enables the client to add or edit existing client data in the new client account.

At step 128, it is determined if the client configure process 120 is to wait for additional client requests. If it is determined at step 128 that the client configure process 120 is to wait for additional client requests, then the client configure process 120 returns to repeat steps 122 through 128. However, if it is determined at step 128 that there are no more client actions to be received, then the client configure process 120 then exits at step 129.

FIG. 5 is a flow chart illustrating an example of the operation of the client analysis process 140 on the server that is utilized in the teledermatology services system 100 of the present invention, as shown in FIGS. 2A-3. Once the new client is placed in server 11, it is available for skin condition analysis. A brief overview of one exemplary process is as follows: 1) is client account established; 2) acquire client images and data and save to client database account; 3) analyze client skin condition images and data; 4) determine if referral to a local doctor is necessary; 5) construct an action plan and treatment protocol; 6) send action plan and treatment protocol to client and save to client's account; and 7) done.

First at step 141, the client analysis process 140 is initialized. This initialization includes the startup routines and processes embedded in the BIOS of the server 11. The initialization also includes the establishment of data values for particular data structures utilized in the client analysis process 140.

At step 142, the client analysis process 140 waits to receive a client transaction. Once a client transaction has been received, the client analysis process 140 then verifies that the client account exists at step 143. If the client account exists, then the client analysis process 140 skip step 145. However, if a client account does not exist for the new client, then the client configure process 120 is performed at step 144.

At step 145, the client images and data is saved in the client's database account. Examples of this include, but are not limited to, the images of this skin condition, images of the skin condition taken at a predetermined distance from the camera, and data describing the current status of the patient and the skin condition. This data is herein defined in further detail with regard to FIG. 7.

At step 146, the client skin condition images and data are analyzed. In one embodiment, the analysis of the skin condition is performed by a dermatologist. The images and the data captured with regard to the client symptoms and skin condition would generally enable a dermatologist to recommend an action plan and treatment protocol. In another embodiment, the client skin condition images can be analyzed by computer analysis. This computer analysis would be much like the computerized analysis of Pap smears and other tissue cultures.

At step 151, it is determined from the analysis at step 146, if a referral to a local doctor is necessary. This would be done in those occasions where it is unclear what the diagnosis of the skin condition may be or if there is some immediate danger to the client.

At step 152, the client analysis process 140 constructs an action plan and treatment protocol for the client skin condition. In those instances were the analysis of the client skin condition and data was performed by a dermatologist, the dermatologist would interact with the client analysis process 140 to create the action plan and treatment protocol. In an alternative and body image, or the analysis of the client skin condition and data is performed by a cuter, then the action plan and treatment protocols would be selected from a variety of predetermined action plans and protocols that cross match with the determination of the client skin condition.

At step 153, the client analysis process 140 updates the client account in database 12 with the action plan and treatment protocols. The client analysis process 140 also forwards the action plan and treatment protocol to the client in the predetermined communication form. The predetermined communication form could be an e-mail, text message (i.e. SMS), snail mail, or by a phone call.

At step 154, it is determined if the client analysis process 140 is to wait for additional client transactions. If it is determined at step 154 that the client analysis process 140 is to wait for additional client transactions, then the client analysis process 140 returns to repeat steps 142 through 154. However, if it is determined at step 154 that there are no more client transactions to be received, then the client analysis process 140 then exits at step 159.

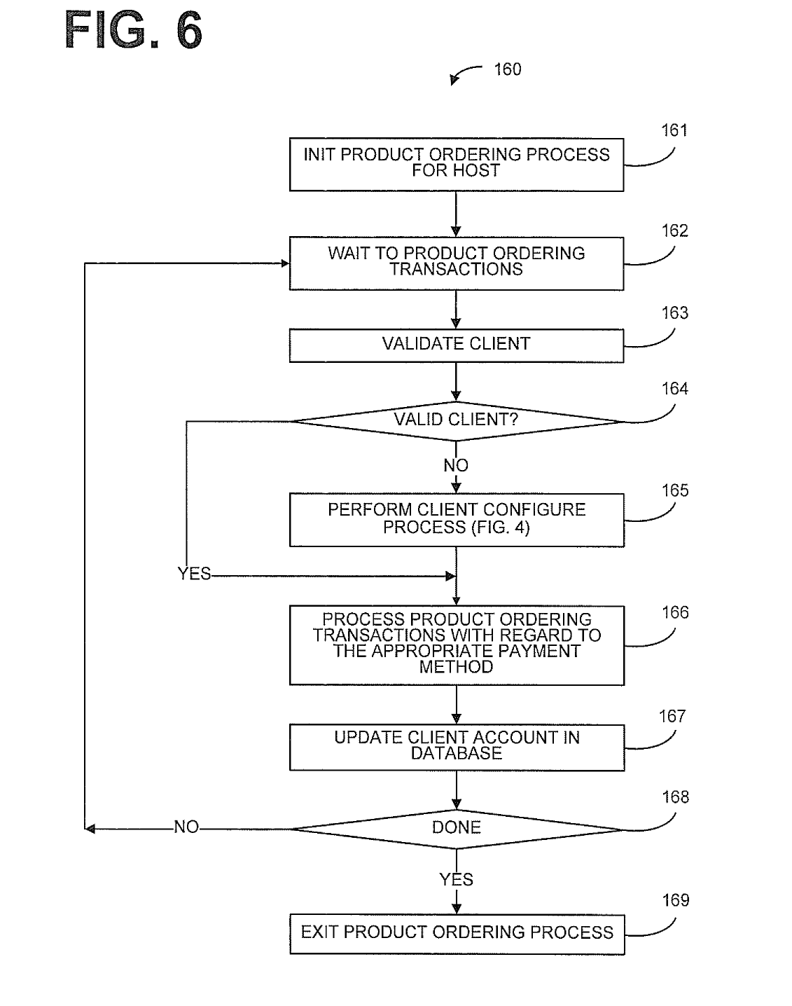

FIG. 6 is a flow chart illustrating an example of the operation of the product ordering process 160 on the host that is utilized in the teledermatology services system 100 of the present invention, as shown in FIGS. 2A-4. The client may order products after receiving the action plan and treatment protocols as determined at step 152 (FIG. 5), as to obtain refills before previously received action plan and treatment protocols, or as a stand-alone acquisition of skin condition treatment. A brief overview of one exemplary process is as follows: 1) the client is validated; 2) creation of a client account if new client; 3) process the client product ordering transaction using the appropriate credit card for the client; 4) update the client account on database 12; and 5) done.

First at step 161, the product ordering process 160 is initialized. This initialization includes the startup routines and processes embedded in the BIOS of the server 11. The initialization also includes the establishment of data values for particular data structures utilized in the product ordering process 160.

At step 162, the product ordering process 160 waits to receive a client transaction. Once a client transaction has been received, the product ordering process 160 then validates the client at step 163. The client is validated against information in database 12 at step 164. If the client is valid, the product ordering process 160 Skip's to step 166. However, if the client is not valid, then the product ordering process 160 performs the client configure process defined with regard to FIG. 4, at step 165.

At step 166, the product ordering process 160 then processes the client product ordering transaction with the appropriate credit card associated with the client account. At step 167, the product ordering process 160 updates the client account to reflect the products ordered in database 12.

At step 168, it is determined if the product ordering process 160 is to wait for additional product ordering transactions. If it is determined at step 168 that the product ordering process 160 is to wait for additional product ordering transactions, then the product ordering process 160 returns to repeat steps 162 through 168. However, if it is determined at step 168 that there are no more client product ordering transactions to be received, then the product ordering process 160 then exits at step 169.

FIG. 7 is a flow chart illustrating an example of the operation of the remote device system 200 on the remote device that is utilized in the teledermatology services system 100 of the present invention, as shown in FIGS. 2B. The remote device system 200 uses known communication means to establish communication with the teledermatology services system 100 on the host. The process flow is illustrated as an example of that data input and output request being performed at the remote device 15. This interaction is preferably implemented using a web browser. However other indication methodologies can be utilized.

First at step 201, the remote device system 200 is initialized on the remote device 15. This initialization includes the startup routines and processes embedded in the BIOS of the remote device 15. The initialization also includes the establishment of data values for particular data structures utilized in the remote device system 200.

At step 202, the remote device system 200 waits to receive an action request. Upon receiving an action request, the remote device system 200 then determines if the client performing the action request is a new client. If it is determined at step two of three that the action request is not from a new client, then the remote device system 200 skips this step 205. However, if it is determined at step two of three that the action request is from a new client, then the remote device system 200 captures the new client data to be sent to the host. This data is then used to create a new client account at step 126 (FIG. 4).

At step 205, it is determined if an analysis action is to occur. If it is determined that step to apply that analysis action is not to occur, then the remote device system 200 and skips the step 214. However, if it is determined at step 205 that an analysis action is to occur, then the images of the skin condition are input into the remote device system 200, at step 211. The images may be acquired by a camera 58 on the remote device 15 or downloaded from an image acquiring device (not shown) to memory 52 utilizing any communication means. The communication means includes but is not limited to USB, FireWire, diskette, CD-ROM, attached e-mail, or the like.

At step 212, the remote device system 200 captures skin condition information that includes, but is not limited to skin type, facial type, skin sensitivity, all locations in frequency of skin condition and other diagnostic information. The other diagnostic information includes, but is not limited to, current skin condition treatments, follow-up frequency, allergies, makeup usage, stress amount, sleep amount, sunlight exposure and the like info. Examples of this skin condition information captured includes for example, but is not limited to, the questions listed below.

### LETS DETERMINE YOUR SKIN TYPE, SKIN TONE, AND ACNE TYPE

YOUR FACIAL SKIN TYPE IS (description of each skin type will pop up as each is passed over with cursor.

OILY? T ZONE OR GENERALIZED; NORMAL; DRY ? T ZONE OR GENERALIZED COMBINATION.

### YOUR FACIAL TONE

VERY FAIR; FAIR; MEDIUM WITH OLIVE; MEDIUM WITHOUT OLIVE; LIGHT BROWN; DARK BROWN or DARK.

### IS YOUR SKIN SENISITVE TO TOPICAL PRODUCTS (GET IRRITATED, STING OR BURN WHEN APPLYING PRODUCT OR AFTER USING PRODUCT SEVERAL TIMES)

NEVER, SOME OF THE TIME, MOST OF THE TIME, ALL THE TIME or WINTER TIME ONLY

### WHAT TYPES OF ACNE LESIONS DO YOU HAVE?

### PHOTOS WITH EACH TYPE, CHECK EACH TYPE THAT YOU HAVE:

BLACK HEADS/WHITE HEADS; RED BUMPS/PUSOR; WHITE BUMPS/DEEP and/or CYSTIC BUMPS.

WHAT OTHER CHANGES HAVE YOU HAD WITH YOUR ACNE? (PHOTOS) RED MARKS, DARKS MARKS, and/or TRUE SCARS (WHICH MAY LEAVE AN INDENTATION).

### WHERE DO YOU GET ACNE DIAGRAM WITH SITES ILLUSTRATED:

FOREHEAD, NOSE, CHEEKS, CHIN, NECK, SHOULDERS and/or CHEST.

### HOW MANY TRUE ACNE BUMPS (NOT MARKS OR SCARS) DO YOU HAVE AT THIS TIME?

GREATER THAN 12; 6-12; 1-5 or NONE.

### HOW OFTEN DO YOU HAVE NEW ACNE BUMPS?

EVERY DAY; SEVERAL TIMES PER WEEK; ONCE A MONTH; AT THE TIME OF MENSTRUAL CYCLE and/or NEVER

### DO YOU TOUCH OR PICK AT YOUR FACE?

NEVER; SOMETIMES or A LOT.

### WHAT TYPES OF PRODUCTS DO YOU USE NOW OR IN THE PAST (CLICK ALL THAT APPLY)

CREAM CLEANSER; GEL CLEANSER; TONER; FOAM CLEANSER; MOISTURIZER; PADS; SCRUBS; MASKS; and/or SPOT TREATMENT.

### WHICH PRODUCTS HAVE YOU USED IN THE PAST:

BIORE; PROACTIVE; MURAD; ACNE ID; NUETRAGENA; OXY; ST IVES; ACNE FREE; PEROXIDE; ALCOHOL; WITCH HAZEL; and/or CLEARSIL. (CLICK ALL THAT APPLY)

### ARE YOU ALLERGIC TO ANY TOPICAL MEDICATIONS OR TREATMENTS?

SAL ACID; BENZOYL PEROXIDE; TRICLOSAN; RETINOL; and/or GLYCOLIC ACID.

### DOES YOUR SKIN BECOME IRRITATED WITH ANY OF THESE MEDICATIONS

NO; A LITTLE DRY; RED; CHAPPED and/or PEELING/RASH.

### DO YOU WEAR MAKEUP?

FOUNDATION; CONCEALER; POWDER; BLUSH and/or NONE.

### MY LIFESTYLE (HELPS ME TO CHOOSE THE BEST ROUTINE FOR YOUR LIFESTYLE)

### HOW DO YOU FEEL ABOUT ACNE TREATMENT PLANS?

I DON'T REALLY STICK TO A SKIN CARE PLAN; I AM TOO BUSY OR I FORGET; I TRY TO STICK TO A SKIN CARE PLAN; I USE IT TWO TO FOUR TIMES A WEEK or I ALWAYS STICK TO MY SKIN CARE PLAN.

### HOW MUCH STRESS DO YOU HAVE IN YOUR LIFE?

LITTLE; SOMETIMES or ALWAYS.

### HOW MUCH SLEEP DO YOU GET A NIGHT?

LESS THAN 4; LESS THAN 5; LESS THAN 6; LESS THAN 7; LESS THAN 8 or MORE THAN 8 HOURS

### WHAT STATE DO YOU LIVE IN?

### HOW MUCH TIME DO YOU SPEND IN DIRECT SUN OR IN A TANNING BED?NONE; 1-2 HOURS or 3-5 HOURS.

### IS THAT DAILY OR WEEKLY?

### WHAT BOTHERS YOU MOST ABOUT YOUR ACNE?

DARK MARKS; RED MARKS; BUMPS; or RECURRENT BREAKOUT WITH NO TIME WITH SKIN BEING CLEAR

At step 213, the images and skin condition information acquired at steps 211 and 212 are sent to the teledermatology services system 100 of the present invention on server 11. The remote device system 200 waits to receive an action plan and treatment protocol from the teledermatology services system 100 of the present invention on server 11.

At step 214, the remote device system 200 then determines if the client wishes to order products for the newly received treatment protocol or to reorder products for a previously determined treatment protocol. If it is determined at step 214 that the client does not wish to order products for the treatment protocol, then the remote device system 200 and skips the step 216. However, if it is determined at step 214 that the client does wish to order products for the treatment protocol, then the product order for the treatment protocol is entered along with the payment method at step 215.

At step 216, it is determined if the remote device system 200 is to wait for additional client actions. If it is determined at step 216 that the remote device system 200 is to wait for additional actions, then the remote device system 200 returns to repeat steps 202 through 216. However, if it is determined at step 216 that there are no more client actions to be received, then the remote device system 200 then exits at step 219.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A method for delivering teledermatology embodied in a computer program product for execution on an instruction processing system, comprising a tangible storage medium readable by the instruction processing system and storing instructions for execution by the instruction processing system for performing the method comprising:
receiving a request from a client for skin analysis;
associating the request to at least one skin condition;
constructing an action plan for treating the at least one skin condition; and
sending the action plan to the client.

2. The method of claim 1, wherein the receiving the client request for skin analysis further comprises receiving an image of the skin condition.

3. The method of claim 1, wherein the receiving the client request for skin analysis further comprises receiving skin condition information.

4. The method of claim 1, further comprising:
determining if a referral to a local doctor is necessary.

5. The method of claim 4, further comprising:
sending the client the referral of at least one doctor's name.

6. The method of claim 1, further comprising:
receiving a request from the client for a product to treat the at least one skin condition.

7. The method of claim 6, further comprising:
sending the product to treat the at least one skin condition to the client.

8. A system that provides teledermatology services on an instruction processing system, comprising:
a tangible storage medium readable by the instruction processing system and storing instructions for execution by the instruction processing system;
means for receiving a request from a client for skin analysis;
means for associating the request to at least one skin condition;
means for constructing an action plan for treating the at least one skin condition; and
means for sending the action plan to the client.

9. The system of claim 8, wherein the means for receiving the client request for skin analysis further comprises means for receiving an image of the skin condition.

10. The system of claim 8, wherein the means for receiving the client request for skin analysis further comprises means for receiving skin condition information.

11. The system of claim 8, further comprising:
a means for determining if a referral to a local doctor is necessary.

12. The system of claim 11, further comprising:
a means for sending the client the referral of at least one doctor's name.

13. The system of claim 8, further comprising:
means for receiving a request from the client for a product to treat the at least one skin condition.

14. The system of claim 13, further comprising:
means for sending the product to treat the at least one skin condition to the client.

15. A computer program product for providing teledermatology services, the computer program product comprising:
a tangible storage medium readable by a computer system and storing instructions for execution by the computer system for performing a method comprising:
receiving a request from a client for skin analysis;
associating the request to at least one skin condition;
constructing an action plan for treating the at least one skin condition; and
sending the action plan to the client.

16. The computer program product of claim 15, wherein the receiving the client request for skin analysis further comprises receiving an image of the skin condition.

17. The computer program product of claim 15, wherein the receiving the client request for skin analysis further comprises receiving skin condition information.

18. The computer program product of claim 15, further comprising:
determining if a referral to a local doctor is necessary.

19. The computer program product of claim 18, further comprising:
sending the client the referral of at least one doctor's name.

20. The computer program product of claim 13, further comprising:
receiving a request from the client for a product to treat the at least one skin condition; and
sending the product to treat the at least one skin condition to the client.
